(19) United States
(12) Patent Application Publication
(10) Pub. No.: US 2007/0077072 A1
(43) Pub. Date: Apr. 5, 2007

(54) Wavelength division multiplexing apparatus

(75) Inventors: Kazuhiro Kunimatsu, Kawasaki (JP); Takeshi Ono, Kawasaki (JP); Toshiki Honda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/324,489

(22) Filed: Jan. 4, 2006

(30) Foreign Application Priority Data
Sep. 30, 2005 (JP) JP2005-286661

(51) Int. Cl. H04B 10/00

(52) U.S. Cl. 398/135

(57) ABSTRACT

A transmitting unit of a transponder transmits a signal light having a wavelength which is set according to a control unit to a WDM unit. In this situation, when the wavelength of the signal light is adapted to a pass wavelength of an optical filter to which the signal light is inputted, the signal light is returned to a transmitting origin through a loopback path formed within the WDM unit, and then received by a receiving unit. The control unit determines the wavelength that has been setting in the transmitting unit when the signal light is received as a transmission wavelength to be used by the transponder.

### BACKGROUND OF THE INVENTION

1. Field of the Invention

The present invention relates to a wavelength division multiplexing apparatus (WDM transmission apparatus) that multiplexes and divides plural signals in wavelength and then transmits the divided signals to thereby attain high-capacity transmission.

2. Description of the Related Art

As shown in FIG. 1, the WDM transmission apparatus includes a transponder unit that converts plural different signals into a specific wavelength, and a WDM unit (wavelength division multiplexing unit) that conducts wavelength multiplexing/division on the converted signal and optically amplifies the wavelength-multiplexed signal.

A wavelength that is subjected to wavelength multiplexing/division in the WDM unit is regulated by ITU-T G.694. The WDM unit generally multiplexes wavelengths that conform to wavelength grids which are regulated by ITU-T G.694. The WDM transmission apparatus of a high-capacity conducts wavelength multiplexing of 40 waves, 80 waves, or more. The transponder unit requires transponders as many as the multiplexed wavelengths. Accordingly, the more the number of multiplexed wavelengths increases, the more the scale of the WDM transmission apparatus is enlarged.

Upon starting (startup of) the WDM transmission apparatus, the transponders as many as the multiplexed wavelengths are connected to the WDM unit through optical fibers, respectively. At this time, wavelengths each corresponding to each wavelength received from a destination of the WDM selection need to be set to the transponders. In the existing circumstances, the connecting work is all conducted manually. The wavelengths of the transponders are also manually set by operator through, for example, a remote control from a central control station. Accordingly, in the start-up operation of the high-capacity WDM transmission apparatus, setting work related to a large number of wavelengths is required. Therefore, the wavelength setting work is very complicated, which leads to a high possibility of a setting error.

Also, in additionally providing (adding) a new wavelength for the WDM transmission apparatus that has already started the operation, the connection and setting work related to the new wavelength are required. In this case, the operator must give consideration to the wavelengths that have already been used to select unused wavelengths or to set the wavelength. In this situation, the operator must conduct the operation while checking a large number of items, which lead to a possibility of a setting error.

In order to eliminate the complication of the above-mentioned wavelength setting work, there has been already proposed a method of automatically setting the transmission wavelengths to the transponders. For example, Patent document 1 discloses “a wavelength-multiplexed light transmission system and an optical signal transmission control method”. In the technique disclosed in Patent document 1, in consideration of the fact that a wavelength multiplexing portion of the WDM unit has a filter and allows a light of only a specific wavelength band to pass therethrough, photodetectors for detection of light intensity are disposed in front and back of the filter to sweep the transmission wavelengths of the transponders in sequence. With this structure, the light intensity can be detected when a wavelength that coincides with that of the destination is set to the transmission wavelength. In addition, a control unit in the WDM unit notifies a control unit in the transponder unit of light detection information to determine the transmission wavelength of the transponders as a set wavelength. In the technique disclosed in Patent document 1, there is required a structure in which information is transferred between the control unit in the WDM unit and the control unit in the transponder unit. Therefore, in a case where the WDM transmission device is structured by the WDM unit and the transponder unit which are different in vender, there is a fear that it is difficult to control the transfer between the WDM unit and the transponder unit. Also, in the technique disclosed in Patent document 1, the transmission wavelength of the transponder is swept to determine the set wavelength. Therefore, a long period of time may be required for the determination.

Also, Patent document 2 discloses “a wavelength-division multiplex system and a method of automatically setting conversion wavelengths in the system”. The technique disclosed in Patent document 2 has not only a function of automatically setting the wavelength but also a function of preventing the misconnection of an optical fiber. The technique disclosed in Patent document 2 has a function of adding the wavelength information of itself by modulation of a main signal between the WDM unit and the transponder unit, with which the level monitor of a light that has passed through a specific filter of the WDM unit, and the demodulation and detection of the wavelength information which has been modulated after passing of the light are executed. As a result, it is possible to determine whether or not the wavelength to be set is accurately connected. The technique disclosed in Patent document 2 is required to provide each the transponder unit and the WDM unit with a modulation function for adding the wavelength information to the main signal.

As described above, in the techniques disclosed in Patent documents 1 and 2, both of the WDM unit and the transponder unit are improved (the function of automatically setting the wavelength is added) to realize the automatic wavelength setting.

[Patent document 1] JP 2004-274113 A

[Patent document 2] JP 2004-015328 A

### SUMMARY OF THE INVENTION

An object of the present invention is to provide a technique by which a transmission wavelength can be automatically set to save a wavelength setting work.

The present invention adopts the following structures in order to the above problem.

That is, one aspect of the present invention provides a wavelength division multiplexing apparatus, including:

a transponder unit that transmits a plurality of signal lights each having a different wavelength from each other; and

a wavelength division multiplexing unit that receives the plurality of signal lights, multiplexes the received signal lights in wavelength, and transmits the multiplexed signal light, and when receiving the wavelength-multiplexed signal lights, divides the wavelength-multiplexed signal light into plural signal lights having the different wavelengths, and transmits the respective divided signal lights to the transponder unit,

in which the transponder unit includes a plurality of transponders, each of which transmits and receives the signal light having one of the plurality of wavelengths with respect to the wavelength division multiplexing unit,

in which the wavelength division multiplexing unit is connected to one of the plural transponders, has a specific pass wavelength, and has a loopback path that returns the signal light to one of the transponders when the wavelength of the signal light that is received from one of the transponders is adapted to the pass wavelength, and

in which one of the transponders, includes:

a transmitting unit that can transmit the signal light having a wavelength according to the setting to the wavelength division multiplexing unit;

a detection unit detecting the signal light that is returned through the loopback path; and

a control unit conducting wavelength setting on the transmitting unit and determining the wavelength that is set in the transmitting unit when the detecting unit detects the signal light as a transmission wavelength to be used by one of the transponder.

Further, the present invention provides an automatic transmission wavelength setting method for a wavelength division multiplexing apparatus which includes: a transponder unit that transmits a plurality of signal lights each having a different wavelength from each other; and

a wavelength division multiplexing unit that receives the plurality of signal lights, multiplexes the received signal lights in wavelength, and transmits the multiplexed signal light, and when receiving the wavelength-multiplexed signal lights, divides the wavelength-multiplexed signal light into plural signal lights having the different wavelengths, and transmits the respective divided signal lights to the transponder unit, in which the transponder unit includes a plurality of transponders that transmit and receive the signal light having one of the plurality of wavelengths with respect to the wavelength division multiplexing unit, the method including:

transmitting the signal light to the wavelength division multiplexing unit by one of the plurality of transponders;

receiving the signal light that returns back from the wavelength division multiplexing unit when the wavelength of the signal light is a wavelength to be used by the one of the plurality of transponders; and

determining the wavelength of the received signal light as a transmission wavelength to be used by the one of the plurality of transponders when the signal light is receive.

Further, the present invention provides a transponder for transmitting one of a plurality of signal lights having different wavelengths from each other to a device that multiplexes the plurality of signal lights in wavelength, the transponder including:

a transmitting unit transmitting the signal light to the device;

a receiving unit receiving the signal light that returns back from the device when the wavelength of the signal light is a wavelength to be used by the transponder; and

a unit determining the wavelength of the received signal light as the transmission wavelength to be used by the transponder when the signal light is received by the receiving unit.

Further, the present invention provides an automatic transmission wavelength setting method for a transponder that transmits one of a plurality of signal lights having different wavelengths from each other to a device that multiplexes the plurality of signal lights in wavelength, the method including:

transmitting the signal light to the device;

receiving the signal light that returns back from the device when the wavelength of the signal light is a wavelength to be used by the transponder; and

determining the wavelength of the received signal light as the transmission wavelength to be used by the transponder when the signal light is received.

Further, the present invention provides a wavelength multiplex apparatus, including:

a wavelength multiplex unit that multiplexes a plurality of signal lights having different wavelengths in wavelength; and

a loopback path that has a specific pass wavelength, is connected to a signal light that is transmitted toward the wavelength multiplex unit, and returns the signal light back to a transmitting origin when the wavelength of the signal light is adapted to the pass wavelength.

According to the present invention, a transmission wavelength of a transponder can be automatically set to save a wavelength setting work.

### BRIEF DESCRIPTION OF THE DRAWINGS

FIG. 1 is a structural diagram showing a conventional WDM transmission apparatus;

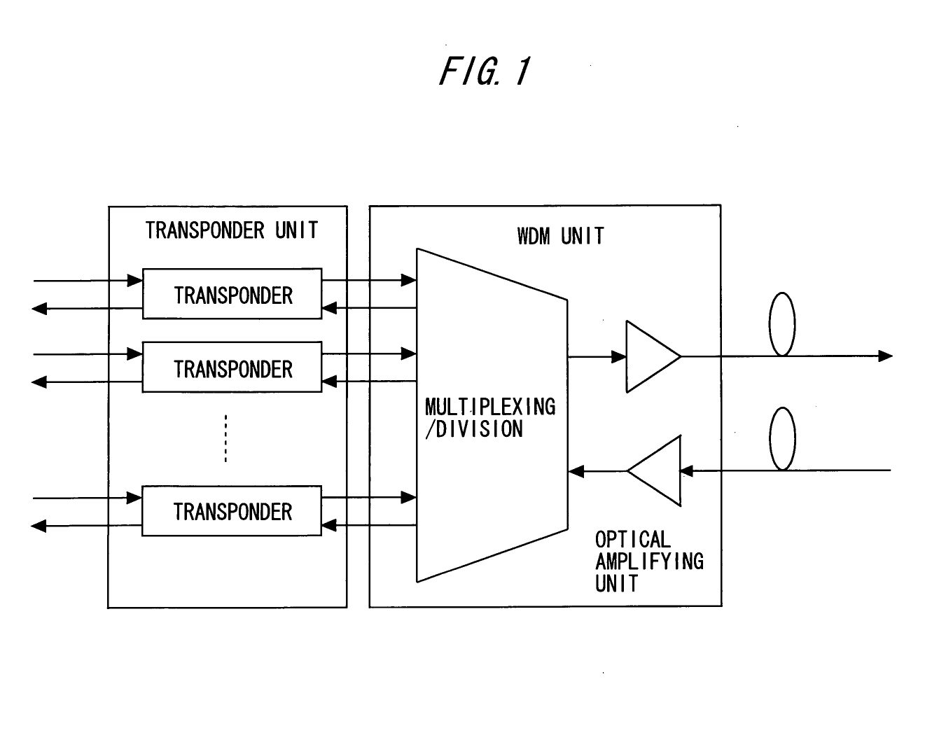

FIG. 2 is a diagram showing a structural example of a WDM transmission apparatus according to a first embodiment;

FIG. 3 is a diagram showing an example of an automatic wavelength setting sequence which is executed by the WDM transmission apparatus according to the first embodiment;

FIG. 4 is a diagram showing a structural example of a WDM transmission apparatus according to a second embodiment;

FIG. 5 is a diagram showing an example of an automatic wavelength setting sequence which is executed by the WDM transmission apparatus according to the second embodiment;

FIG. 6 is a diagram showing a structural example of a WDM transmission apparatus according to a third embodiment;

FIG. 7 is a diagram showing an example of an automatic wavelength setting sequence which is executed by the WDM transmission apparatus according to the third embodiment;

FIG. 8 is a diagram showing a structural example of a WDM transmission apparatus according to a fourth embodiment;

FIG. 9 is a diagram showing a structural example of a WDM transmission apparatus according to a fifth embodiment;

FIG. 10 is a diagram showing a structural example of a WDM transmission apparatus according to a sixth embodiment;

FIG. 11 is a diagram showing a structural example of a WDM transmission apparatus according to a seventh embodiment;

FIG. 12 is a diagram showing an example of an automatic wavelength setting sequence which is executed by the WDM transmission apparatus according to the seventh embodiment;

FIG. 13 is a diagram showing a structural example of a WDM transmission apparatus according to an eighth embodiment;

FIG. 14 is a diagram showing an example of an automatic wavelength setting sequence which is executed by the WDM transmission apparatus according to the eighth embodiment;

FIG. 15 is a diagram showing a structural example of a WDM transmission apparatus according to a ninth embodiment;

FIG. 16 is a diagram showing a structural example of a reflection/transmission unit shown in FIG. 15; and

FIG. 17 is a diagram showing an example of an automatic wavelength setting sequence which is executed by the WDM transmission apparatus according to the ninth embodiment.

### DETAILED DESCRIPTION OF THE PREFERRED EMBODIMENTS

Hereinafter, a description will be given of embodiments of the present invention with reference to the accompanying drawings. In the following description, structures of the embodiments are examples, and the present invention is not limited to the structures of the embodiments.

### First Embodiment

<Apparatus Structure>

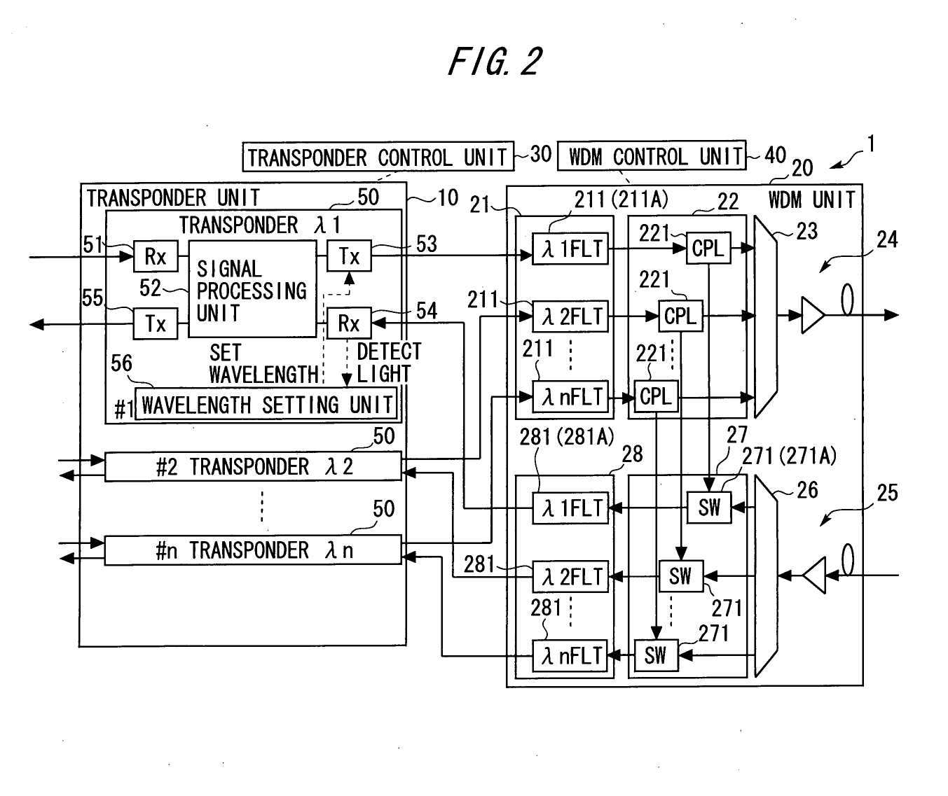

FIG. 2 is a diagram showing a structural example of a wavelength division multiplexing apparatus (WDM transmission apparatus) according to a first embodiment of the present invention. Referring to FIG. 2, the WDM transmission apparatus 1 includes a transponder unit 10, a WDM unit (wavelength division multiplexing unit) 20 that is connected to the transponder unit 10, a transponder control unit 30 that controls the transponder unit 10, and a WDM control unit 40 that controls the WDM unit 20.

The WDM transmission apparatus 1 multiplexes plural signal lights each having a specific wavelength different from each other in wavelength in a direction from the transponder unit 10 toward the WDM unit 20 (in an upstream direction) and then sends the multiplexed signal light to a connected portion in the upstream direction. On the contrary, the WDM transmission apparatus 1 divides the signal light that has been multiplexed in wavelength into plural signal lights each having a specific wavelength different from each other in wavelength in a direction from the WDM unit 20 toward the transponder unit 10 (in a downstream direction) and then sends the respective divided signal lights to respective connected portions in the downstream direction.

In order to multiplex various signals ((SONET/SDH, Ethernet (registered trademark), SAN, etc.) in wavelength by the WDM transmission apparatus 1, the transponder unit 10 receives the various signals from the respective connected portions in the downstream direction, generates plural signal lights each having a specific wavelength different from each other by wavelength conversion, and transmits the plural signal lights to the WDM unit 20. Plural wavelengths corresponding to wavelength grids that are regulated by, for example, ITU-T G.694 can be applied as the different specific wavelengths.

The WDM unit 20 multiplexes the plural signal lights that are transmitted from the transponder unit 10 in wavelength, amplifies the multiplexed signal light, and then transmits the amplified signal light toward a destination (a connected portion in the upstream direction). Also, the WDM unit 20 receives the light multiplexed in wavelength (the signal light resulting from multiplexing the plural signal lights each having the specific wavelength different from each other in wavelength) from the connected portion in the downstream direction and amplifies the wavelength-multiplexed light, and thereafter divides the amplified light into the signal lights having the respective wavelengths and transmits the divided signals to the transponder unit 10. After having been subjected to required processing, the respective signal lights that have been received by the transponder unit 10 are sent from the transponder unit 10 toward the destinations of the respective signal lights.

The transponder unit 10 has plural transponders 50 which are prepared with respect to each of wavelengths λs (s=1, 2, . . . , n−1, n: n is a natural number) which are dealt with by the WDM transmission apparatus 1. Each of the transponders 50 has a tunable transmitter which is capable of transmitting a signal light of a transmission wavelength set in the tunable transmitter to the WDM unit 20. The wavelength different from each other is set in each of the transponders 50 as the transmission wavelength. That is, as shown in FIG. 2, the wavelengths λ1 to λn different from each other are set in the respective transponders 50 as the transmission wavelengths.

The respective transponders 50 are identical in structure with each other. As shown in FIG. 2, each of the transponders 50 includes a receiving unit (Rx) 51 that receives the signal light from the connected portion in the downstream direction, a signal processing unit 52 that conducts a predetermined process on the signal light which is received by the transponder 50, and a transmitting unit (Tx: tunable transmitter) 53 that converts the signal light from the signal processing unit 52 into a signal light having a set transmission wavelength and transmits the converted signal light. As a result, each of the transponders 50 transmits the signal light having one of the plural wavelengths which are multiplexed in wavelength by the WDM unit 20 to the WDM unit 20.

Also, the transponder 50 includes a receiving unit (Rx: receiver) 54 that receives the signal light from the WDM unit 20. The receiving unit 54 receives the signal light having the same wavelength as that of the transmission wavelength which is transmitted from the transmitting unit 53. The light that has been received by the receiving unit 54 is sent to the connected portion in the downstream direction from the transmitting unit (Tx) 55 after having been subjected to a required process by the signal processing unit 52.

In addition, the transponder 50 includes a wavelength setting unit 56 that executes a wavelength setting process with respect to the transmitting unit 55 and an automatic wavelength setting control including the wavelength setting process on the basis of the wavelength of the signal light which is received by the receiving unit 54.

The WDM unit 20 is roughly classified into a multiplex system and a division system. The multiplex system includes an optical filter unit 21, a light split unit 22, a wavelength multiplex unit 23, and an optical amplifying unit 24. The optical filter unit 21 includes plural optical filters 211 which are provided in correspondence with the number of plural wavelengths λs (λ1 to λn) which are used in the WDM transmission apparatus 1. The optical filter 211 has a pass wavelength band that allows one of the plural wavelengths λs to pass through the optical filter 211. The optical filter 211 is connected to the transmitting unit 53 in one of the plural transponders 50 through an optical fiber. Accordingly, each of the transmitting units 53 that is connected to the corresponding optical filter 211 is set with a transmission wavelength corresponding to the pass wavelength band of the optical filter 211.

The optical split unit 22 has plural optical fiber couplers (CPL: optical splitter) 221 corresponding to the respective optical filters 211. Each of the CPL 211 is disposed on each of optical paths of wavelengths λ1 to λn which is formed between each of the optical filters 211 and the wavelength multiplex unit 23. Each of the CPL 211 distributes the signal light that is outputted from the corresponding optical filter 211 to the wavelength multiplex unit 23 and an optical switch unit 27.

The wavelength multiplex unit 23 multiplexes the wavelengths λ1 to λn which are outputted from the respective CPL 23 in wavelength. The optical amplifying unit 24 is formed of, for example, an optical fiber amplifier which amplifies the signal light (wavelength-multiplexed signal) which has been multiplexed in wavelength and outputted from the wavelength multiplex unit 23, and outputs the amplified signal light. The wavelength-multiplexed light that has been outputted from the optical amplifying unit 24 is transmitted toward its destination (connected portion at the WDM unit side).

On the other hand, the division system of the WDM unit 20 includes an optical amplifying unit 25, a wavelength division unit 26, an optical switch unit 271, and an optical filter unit 28. The optical amplifying unit 25 is formed of, for example, an optical fiber amplifier which amplifies wavelength-multiplexed light which is received from the connected portion (opposed device) at the WDM unit side over a full band. The wavelength-multiplexed light that is outputted from the optical amplifying unit 25 is inputted to the wavelength division unit 26. The wavelength division unit 26 divides the wavelength-multiplexed light into the signal lights of the wavelengths λ1 to λn, and outputs the divided signal lights.

The optical switch unit 27 has plural optical switches (SW) 271 corresponding to the wavelengths λ1 to λn. Each of the SW 271 is disposed on each of the optical paths having the wavelengths λ1 to λn which are formed between the wavelength division unit 26 and the optical filter unit 28. Also, each of the SW 271 is connected to a CPL 601 of the corresponding wavelength λs, for example, through an optical fiber. As a result, each of the SW 271 can receive the signal light having the same wavelength λs from both of the CPL 221 and the wavelength division unit 26.

Each of the SWs 271 connects one of the signal light from the CPL 221 and the signal light from the wavelength division unit 26 to the optical filter unit 281. That is, each of the SWs 271 selects (switches over) the signal light between the CPL (optical split unit) side and the wavelength division unit side.

The optical filter unit 28 has plural optical filters 281 corresponding to the wavelengths λ1 to λn. Each of the optical filters 281 has a pass wavelength band corresponding to any one of the wavelengths λ1 to λn as with the optical filters 211. Each of the optical filters 281 is connected to an SW 271 that outputs the signal light corresponding to its own mass wavelength band.

Also, each of the optical filters 281 is connected to the receiving unit 54 of the transponder 50 through an optical fiber. In this situation, each of the optical filters 281 is connected to the receiving unit 54 such that the receiving unit 54 receives the signal light having the same wavelength as the transmission wavelength. For example, the optical filter 281 that outputs the wavelength λ1 is connected to the receiving unit 54 of the transponder 50 having the transmission wavelength λ1. As a result, each of the transponders 50 transmits and receives the signal light having a specific wavelength λs with respect to the WDM unit 20.

<Automatic Transmission Wavelength Setting>

Subsequently, a description will be given of the structure of an automatic transmission wavelength setting in the WDM transmission apparatus 1. In the above structure, a loopback path is formed with respect to the respective wavelengths λ1 to λn within the WDM unit 20. The loopback path passes through a route of (the transmission unit 53), the optical filter 211, the CPL 221, the SW 271, the optical filter 281, and (the receiving unit 54) in the stated order. In the case where the SW 271 selects the CPK side (optical split unit 22), each of the transponders 50 can receive the signal light (self transmission light) which has been transmitted from the transmitting unit 53 of the subject apparatus by the receiving unit 54 of the subject apparatus through the loopback path.

The receiving unit 54 can receive the signal light that has been transmitted from the transmitting unit 53 only when the transmission wavelength that is set in the transmitting unit 53 is adapted to the pass wavelength band of the optical filter 211. This is because, in the case where the wavelength of the signal light is not adapted to the pass wavelength band, the receiving unit 54 cannot receive the signal light since the signal light is cut off by the optical filter 211.

The present invention is characterized in that when the transponder 50 transmits the signal light from the transmitting unit 53 at a certain wavelength, and the receiving unit 54 can receive that signal light, the wavelength of that signal light is applied as the transmission wavelength, in addition to the above structure. Therefore, each of the transponders 50 is structured as follows.

That is, the wavelength setting unit 56 is so structured as to set the wavelengths λ1 to λn which are used in the WDM transmission apparatus 1 as the transmission wavelengths of the transmitting unit 53. That is, the wavelength setting unit 56 can set each of the wavelengths λs (λ1 to λn) that are defined as wavelengths to be set (candidate set wavelengths) in the transmitting unit 53 as the transmission wavelength. Also, the receiving unit 54 has a detection unit (for example, a photodetector (not shown)) which detects the signal light (received light) from the WDM unit 20, and notifies the wavelength setting unit 56 of the received light detection when detecting the received light.

The wavelength setting unit 56 has wavelength data (data of the wavelength grid) indicative of, for example, the wavelengths λ1 to λn (for example, stored in a memory device), and sequentially sets any one of the wavelengths λ1 to λn by using the wavelength data in the case where the transmission wavelength of the transponder 50 is determined. The wavelength setting unit 56 monitors (determines) whether the signal light is detected by the receiving unit 54, or not, in each of the wavelength setting. When the signal light is detected by the receiving unit 54, the wave setting unit 56 stops the wavelength setting change, and determines (applies) the wavelength that is set in the transmitting unit 53 at that time as the transmission wavelength.

In the case where the wavelength setting unit 56 executes the above process, the corresponding SW 271 executes the switching control that selects the CPL side. The switching control is executed by, for example, the WDM control unit 40. Also, in the case where the wavelength setting unit 56 executes the above process, a transmission wavelength setting light is inputted to the transmitting unit 53.

The wavelength setting unit 56 is made up of, for example, a processor such as a CPU, a memory device that stores program or data therein, and an input/output interface, and the processor executes the program to execute the wavelength setting.

Note that the transponder 50 conducts the transmission to the WDM unit 20 and the reception from the WDM unit 20 as one pair is the implementing condition of the first embodiment.

<Operational Example>

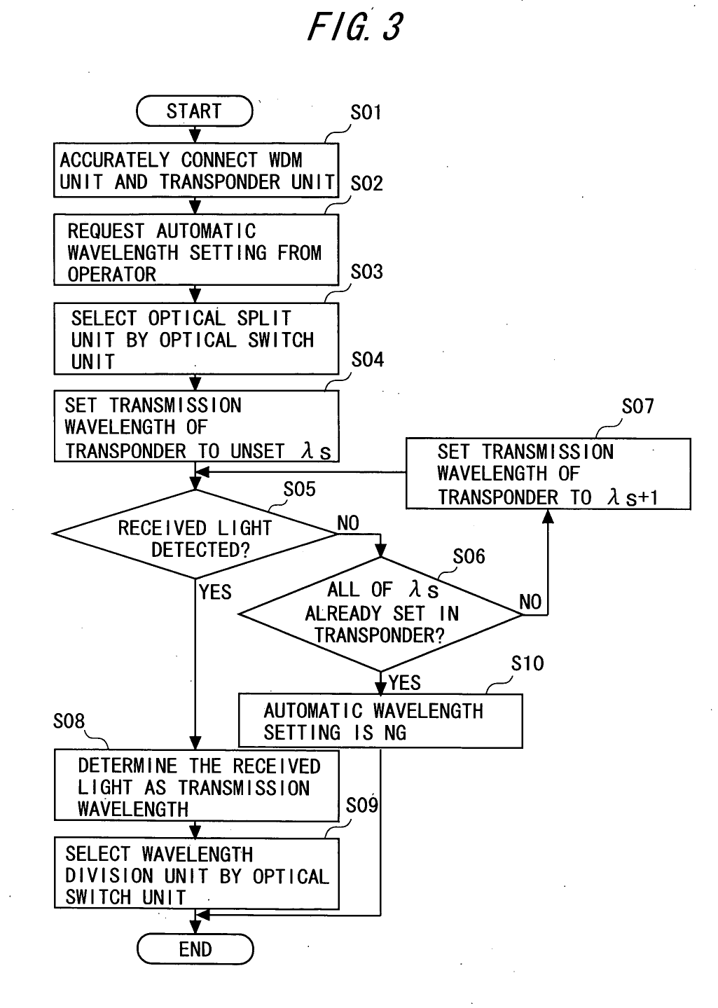

FIG. 3 is a diagram showing an automatic wavelength setting sequence which is executed by the WDM transmission apparatus 1 of the first embodiment. In this example, the operation (automatic transmission wavelength setting method) of the WDM transmission apparatus 1 will be described with an example of the automatic wavelength setting of the wavelength λ1 with reference to FIG. 3.

Referring to FIG. 3, the transponder 50 to be set in wavelength is first accurately connected to the WDM unit 20 (Step S01). That is, the transmitting unit 53 of the transponder 50 (#1) is connected to an optical filter 211A of the WDM unit 20 through an optical fiber, and the receiving unit 54 is connected to an optical filter 281A of the WDM unit through an optical fiber.

Subsequently, an operator inputs an automatic wavelength setting request command to the transponder control unit 30 and the WDM control unit 40 (Step S02). This request command can include the designation of at least one wavelength λs to be set. That is, it is possible to conduct the automatic wavelength setting wavelength by wavelength individually, and conduct the automatic wavelength setting with respect to the plural wavelength concurrently. Also, the request command includes identification information of the transponder 50 to be set in wavelength. In this example, the request command includes the identification information of the transponder 50 (#1) and the designation (designated wavelength information) of the wavelength λ1 to be set in transmission wavelength.

Upon receiving the request command, the WDM control unit 40 controls the optical switch unit 27 according to the designated wavelength information included in the request command. The WDM control unit 40 has data indicative of the relation between the wavelengths λs and the respective SWs 271, and allows the optical switch 271 corresponding to the designated wavelength λs (in this example, the optical switch 271A corresponding to the designated wavelength λ1) to select the optical split unit 22 (switch to the CPL side: Step S03).

On the other hand, upon receiving the request command, the transponder control unit 30 instructs the respective transponders 50 (transponder 50 (#1)) having the identification information included in the request command to conduct the automatic transmission wavelength setting. This instruction is given to the wavelength setting unit 56. Upon receiving the instruction, the wavelength setting unit 56 sets one of the wavelengths to be set (plural wavelengths λs) to the transmitting unit 53 (Step S54). For example, the wavelength setting unit 56 sets the wavelength to the transmitting unit 53 according to a predetermined order (for example, a stated order of λ1, λ2, . . . , λn−1, λn). In this operational example, the wavelength setting unit 56 sets the transmission wavelength as λs=λ1 in Step S04.

After setting the transmission wavelength, the transmitting unit 53 converts the signal light that is inputted to the transmitting unit 53 into the set wavelength, and transmits the converted wavelength to the WDM unit 20. Therefore, it is necessary that light of one arbitrary wavelength is inputted to the transmitting unit 53 before the processing in Step S05 is executed.

After conducting the transmission wavelength setting, the wavelength setting unit 56 monitors the reception of light by the receiving unit 54 for a given period of time (Step S05). That is, in the case where the wavelength that is set in Step S04 is adapted to the pass wavelength (pass wavelength band) of the corresponding optical filters 211 and 281, the light that has been transmitted from the transmitting unit 53 is received by the receiving unit 54 through the loopback path within the WDM unit 20, and the light detection is notified the wavelength setting unit 56 of. On the contrary, in the case where the transmission wavelength is not adapted to the pass wavelength, the receiving unit 54 does not notify the wavelength setting unit 56 of the light detection since the light is cut off by the optical filter 211.

When receiving the notification from the receiving unit 54, the wavelength setting unit 56 determines that the present transmission wavelength is a wavelength adapted to the connected portion (WDM unit 20) (YES in S05), and processing is advanced to Step S08. On the contrary, when not receiving the notification from the receiving unit 54, the wavelength setting unit 56 that the transmission wavelength is improper (NO in S05), and processing is advanced to Step S06.

In Step S06, the wavelength setting unit 56 determines whether all of the wavelengths to be set (λ1 to λn) are set with respect to the transponder 50 (transmitting unit 53), or not. In this situation, in the case where all of the wavelengths to be set are set (YES in S06), the wavelength setting unit 56 recognizes that the automatic wavelength setting is NG (Step S10), and the automatic wavelength setting sequence is finished. In this case, the wavelength setting unit 56 can be structured such that the abnormality of the WDM unit 20 (automatic wavelength setting is NG) is notified the operator of.

On the contrary, in the case where all of the wavelengths to be set are not set (Step S11), the wavelength setting unit 56 changes the transmission wavelength set in the transmitting unit 53 to one of the wavelengths to be set which are not set (Step S07). For example, a wavelength corresponding to a wavelength λs+1 subsequent to the present wavelength λs (wavelength grid) is set in the transmitting unit 53. Thereafter, processing is returned to Step S05.

In this operational example, the wavelength λ1 is set in the transmitting unit 53 in Step S04. The wavelength λ1 is adapted to the pass wavelengths of the corresponding optical filters 211A and 281A. Accordingly, the light of the wavelength λ1 passes through the loopback path and is received by the receiving unit 54, and the reception is detected. Therefore, processing is advanced to Step S08.

When the wavelength that is designated by the request command is not λ1 but λ2, the light reception is not detected in Step S05. In this case, the transmission wavelength that is set in the transmitting unit 53 is changed from λ1 to λ2 (λs+1) through Step S06, in Step S07.

In the case where processing is advanced to Step S08, the wavelength setting unit 56 determines the present transmission wavelength (λ1) as the set wavelength (transmission wavelength) of the transponder 50 (#1). Then, the wavelength setting unit 56 stops the setting change of the wavelength, notifies the transponder control unit 30 of the fact that the setting of the transmission wavelength has been completed, and completes the processing thereof.

The transponder control unit 30 notifies the WDM control unit 40 of the wavelength setting completion. Upon receiving the notification of completion, the WDM control unit 40 switches over the optical switch 271 that selects the optical split unit 22 to the selection of the wavelength division unit 26 (Step S09). In the operational example, the optical switch 271A selects the wavelength split unit 26. As a result, the operation status related to the wavelength λ1 is ensured.

Upon completion of the processing in Step S09, the automatic wavelength setting sequence is completed. In this situation, the normal completion of the automatic wavelength setting sequence is notified the operator of.

<Operation and Effects>

In the WDM transmission apparatus 1 according to the first embodiment, the WDM unit 20 can structure a loopback path that returns the light which is received from the transponder 50 back to the transmitting transponder 50. Disposed on the loopback path are the optical filter 211 and the optical filter 281 which allows a specific wavelength λs to pass therethrough. That is, the loopback path has a specific pass wavelength.

On the other hand, the transponder 50 includes a transmitting unit (transmitting unit 53: tunable transmitter) which is capable of transmitting lights of plural different wavelengths according to the setting, a receiving unit (receiving unit 54) that receives the lights that have been returned through the loopback path, and a control unit (wavelength setting unit 56) that sets the lights of the plural different wavelengths in the transmitting unit, and determines the wavelength that is set in the transmitting unit when the reception of the light by the receiving unit is detected as the transmission wavelength which is used in the transponder 50.

Therefore, according to the WDM transmission apparatus 1, when the WDM transmission apparatus starts up (sets up) or the wavelength is additionally provided, the transponder 50 detects the adapted wavelength and sets the detected adapted wavelength as the transmission wavelength of the transponder only by connecting the transponder 50 and the WDM unit 20 through an optical fiber, and inputting the automatic wavelength setting request command. As a result, since the wavelength setting operation is automated, the operation is saved and simplified. Also, a fear that a setting error occurs due to the manual setting operation by the operator can be eliminated.

Also, in the case where the wavelength setting operation for the plural wavelengths is executed, the automatic wavelength setting instruction can be given to the plural corresponding transponders 50 by one request command. In this situation, the respective transponders 50 can execute the automatic wavelength setting process independently. As a result, a period of time necessary to conduct a large number of wavelength setting can be remarkably reduced.

Also, the loopback path is made up of an optical path of the wavelengths to be multiplexed in the multiplex system of the WDM unit 20 (an optical path that extends to the wavelength multiplex unit 23 since the light is received by the WDM unit 20: first optical path), an optical path of the wavelengths that have been divided in the division system (an optical path until the respective wavelengths that have been divided by the wavelength division unit 26 are transmitted: second optical path), and a connection optical path that connects between those first and second optical paths. The loopback path is realized by disposing the CPL and the optical switch at cross points of the connection optical path and the first and second optical paths. In this way, the loopback path can be structured with a simple improvement using the simple parts.

Also, the control of the WDM unit related to the automatic wavelength setting is only the changeover control of the optical switch before and after the wavelength setting operation due to the transponder 50. Accordingly, it is unnecessary to conduct complicated control by the WDM unit in the automatic wavelength setting. Also, the respective wavelengths λ1 to λn of the receiving system can change over between the operation state and the wavelength setting state only under the control of the optical switch 271.

<Modified Example>

In the first embodiment, the loopback paths are structured with respect to all of the wavelengths λ1 to λn that are used in the WDM transmission apparatus 1, and all of the transponders 50 are identical in the structure (automatic wavelength setting function (wavelength setting unit 62)) with each other.

The WDM transmission apparatus (wavelength division multiplexing apparatus) according to the present invention can be structured in such a manner that the WDM unit (wavelength division multiplexing unit) includes the loopback path of at least one wavelength, and the transponder that is connected to the loopback path has the automatic wavelength setting function. That the number of transponders (the number of wavelengths having the loopback paths) is arbitrary as described above is applied to second to ninth embodiments described below.

### Second Embodiment

Subsequently, a description will be given of a wavelength division multiplexing apparatus (WDM transmission apparatus) according to a second embodiment of the present invention. The second embodiment includes the features common to those of the first embodiment, and therefore differences therebetween will be mainly described, and the description of the common features will be omitted.

<Apparatus Structure>

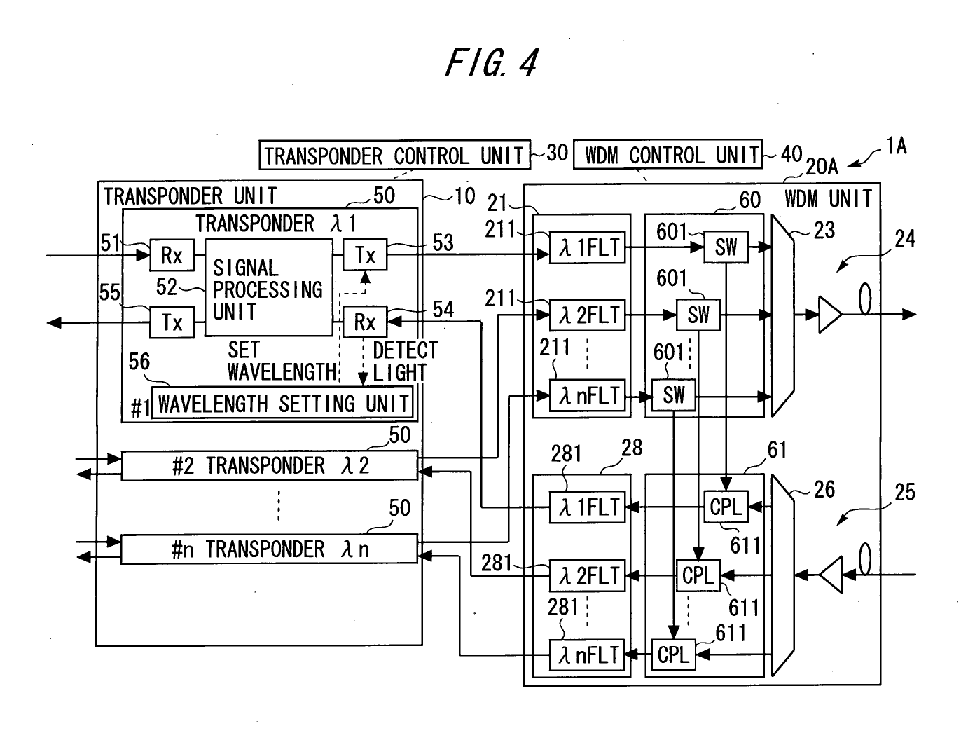

FIG. 4 is a diagram showing a structural example of a WDM transmission apparatus according to the second embodiment. In FIG. 4, the same structural elements as those in the WDM transmission apparatus 1 shown in FIG. 2 are denoted by identical symbols.

A WDM transmission apparatus 1A is different from the WDM transmission apparatus 1 as follows: That is, in a WDM unit 20A, an optical switch unit 60 is inserted between the optical filter unit 21 and the wavelength multiplex unit 23 instead of the optical split unit 22. Also, an optical coupling unit 60 is inserted between the wavelength division unit 26 and the optical filter unit 28 instead of the optical switch unit 27 in the WDM unit 20A.

The optical switch unit 60 has plural optical switches (SW) 601 that are disposed (inserted) on optical paths (main signal optical paths) of the respective wavelengths λ1 to λn which are disposed between the respective optical filters 211 and the wavelength multiplex unit 23. Each of the SWs 601 connects the light from the optical filter 211 to one of the wavelength multiplex unit 23 and the optical coupling unit 61 (selects one of those units) With the above structure, in the case where the SW 601 selects the wavelength multiplex unit 23, the signal light from the optical filter 211 is inputted to the wavelength multiplex unit 23. In the case where the SW 601 selects the optical coupling unit 61, the signal light from the optical filter 211 is inputted to the optical coupling unit 61. The changeover (select) control of the respective SWs 601 is executed by the WDM control unit 40.

The optical coupling unit 61 includes plural CPLs (couplers) 611 that are disposed (inserted) on the optical paths (main signal optical paths) of the respective wavelengths λ1 to λn which are formed between the wavelength division unit 26 and the respective optical filters 281. Each of the CPLs is connected to the SW 601 of the corresponding wavelength λs, for example, through an optical fiber. The CPL 611 inserts the light from the SW 601 into the main signal optical path between the wavelength division unit 26 and the optical filter 281. That is, the CPL 611 can couple the signal light from the wavelength division unit 26 with the signal light from the SW 601.

Except for the above structure, the WDM transmission apparatus 1A has the same structure as that of the WDM transmission apparatus 1. That is, the WDM transmission apparatus 1A (WDM unit 20A) replaces the optical parts (CPL and optical switch (SW)) which are disposed at the cross points of the first and second optical paths and the connection optical path in the WDM transmission apparatus 1 (WDM unit 20) described in the first embodiment.

In the above structure, the WDM unit 20A includes the loopback paths composed of the optical filter 211, the SW 601, the CPL 611, and the optical filter 281 through which the light from the transmitting unit 53 passes in the stated order in the respective wavelengths λ1 to λn. Therefore, each of the transponders 50 detects the reception of the light that returns to the subject apparatus (transponder itself) through the loopback path, and can determine the wavelength that is set in the transmitting unit 53 at that time as the transmission wavelength of the subject apparatus.

<Operational Example>

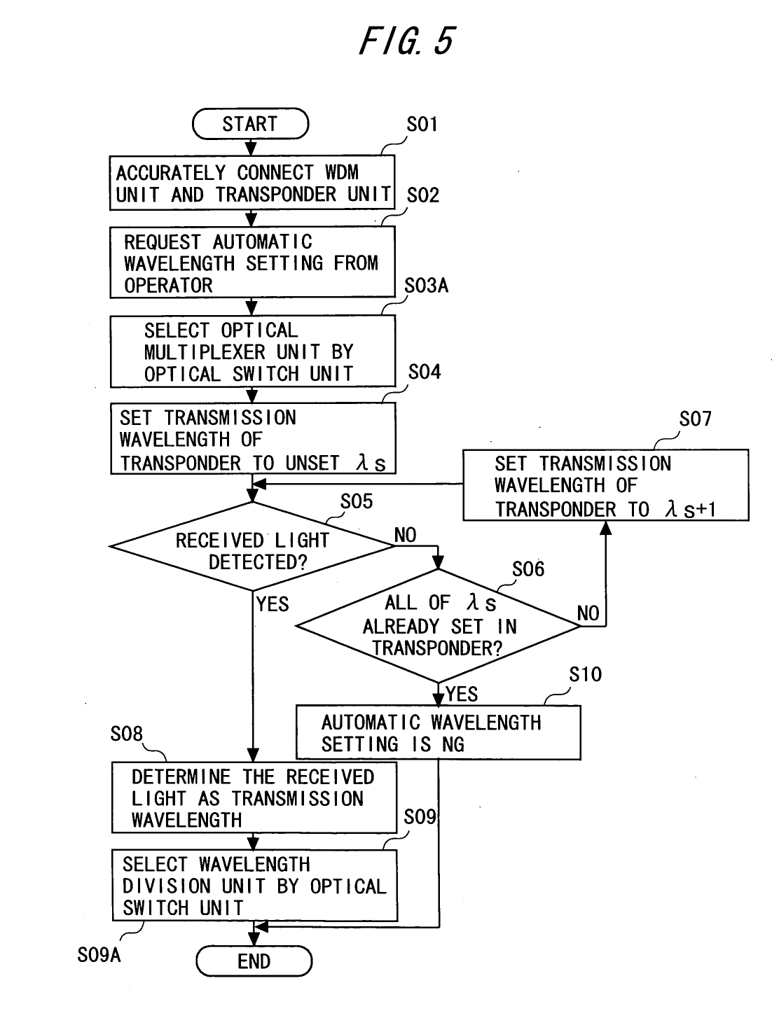

FIG. 5 is a diagram showing an automatic wavelength setting sequence which is executed by the WDM transmission apparatus 1A according to the second embodiment. A process shown in FIG. 5 (operational example) is identical with the operational example according to the first embodiment shown in FIG. 3 except that the WDM control unit 40 controls the changeover of the SW 601 corresponding to the wavelength λs to be set. Therefore, the detailed description will be omitted. In the second embodiment, it is necessary that the signal light from the wavelength division unit 26 is not outputted during at least the processes of Steps S05 to S09A.

<Operation and Effects>

According to the WDM transmission apparatus 1A of the second embodiment, there can be obtained the substantially same operation and effects as those in the WDM transmission apparatus 1 described in the first embodiment.

### Third Embodiment

Subsequently, a description will be given of a wavelength division multiplexing apparatus (WDM transmission apparatus) according to a third embodiment of the present invention. The third embodiment includes the features common to those of the first and second embodiments, and therefore differences therebetween will be mainly described, and the description of the common features will be omitted.

<Apparatus Structure>

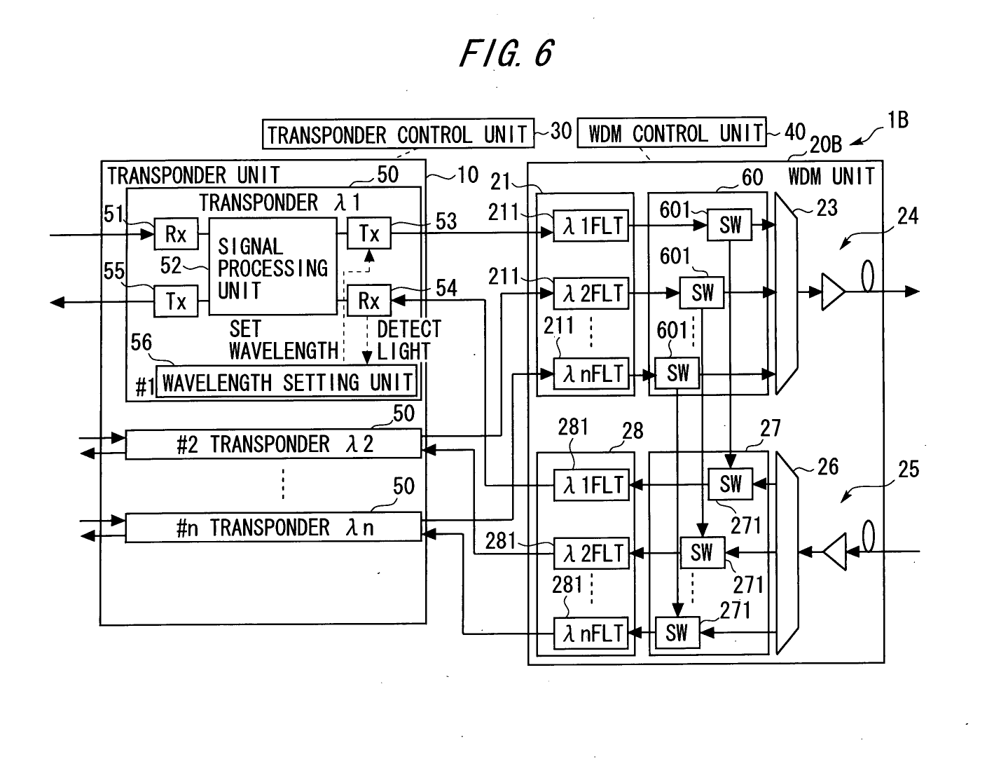

FIG. 6 is a diagram showing a structural example of a WDM transmission apparatus according to the third embodiment. In FIG. 6, the same structural elements as those in the WDM transmission apparatuses 1 and 1A shown in FIGS. 2 and 4 are denoted by identical symbols.

A WDM transmission apparatus 1B is different from the WDM transmission apparatus 1A (FIG. 4) as follows: That is, the same optical switch unit 27 as that in the WDM transmission apparatus 1 is disposed (inserted) between the wavelength division unit 26 and the optical filter unit 28 in the WDM unit 20B. Each of the respective SWs 271 included in the optical switch unit 27 is connected to an SW 601 of the corresponding wavelength λs, for example, through an optical fiber.

Each of the SWs 601 is so structured as to conduct the switching operation between the wavelength multiplex unit 23 and the optical switch unit 27, and each of the SWs 271 is so structured as to conduct the switching operation between the wavelength division unit 26 and the optical switch unit 60. The SWs 271 and 601 related to the same wavelength λs are so controlled as to conduct the switching operation in synchronization. The switching control is conducted by the WDM control unit 40.

Except for the above structure, the WDM transmission apparatus 1B has the same structure as that of the WDM transmission apparatus 1A. That is, in the WDM unit 20B, both of the optical parts that are disposed at the respective cross points of the first and second optical paths and the connection optical path are formed of optical switches.

In the above structure, the WDM unit 20B has a loopback path composed of the optical filter 211, SW 601, SW 271, and the optical filter 281, through which the light from the transmitting unit 53 passes in the stated order in the respective wavelengths λ1 to λn. Therefore, each of the transponders 50 detects the reception of the light that returns to the subject apparatus through the loopback path, and can determine the wavelength that is set in the transmitting unit 53 at that time as the transmission wavelength of the subject apparatus.

<Operational Example>

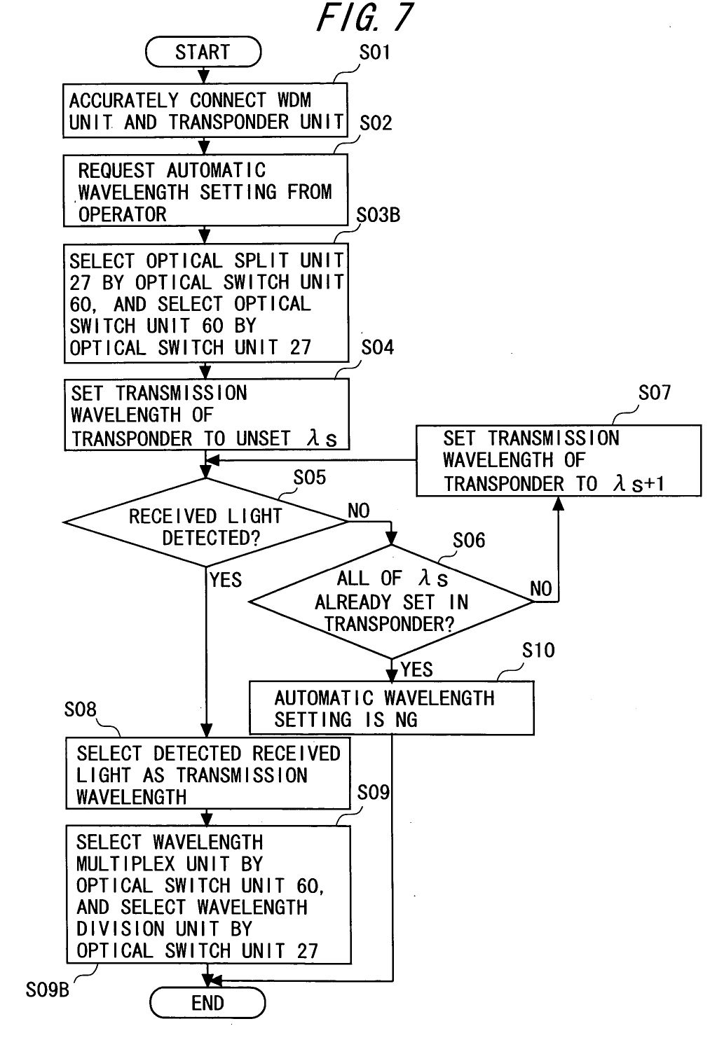

FIG. 7 is a diagram showing an automatic wavelength setting sequence which is executed by the WDM transmission apparatus 1B according to the third embodiment. A process shown in FIG. 7 (operational example) is identical with the operational example according to the second embodiment shown in FIG. 5 except that the WDM control unit 40 controls the changeover of the SW 601 and SW 271 corresponding to the wavelength λs to be set. Therefore, the detailed description will be omitted.

<Operation and Effects>

According to the WDM transmission apparatus 1B of the third embodiment, there can be obtained the substantially same operation and effects as those in the WDM transmission apparatus 1 described in the first embodiment.

### Fourth Embodiment

Subsequently, a description will be given of a wavelength division multiplexing apparatus (WDM transmission apparatus) according to a fourth embodiment of the present invention. The fourth embodiment includes the features common to those of the first embodiment, and therefore differences therebetween will be mainly described, and the description of the common features will be omitted.

<Apparatus Structure>

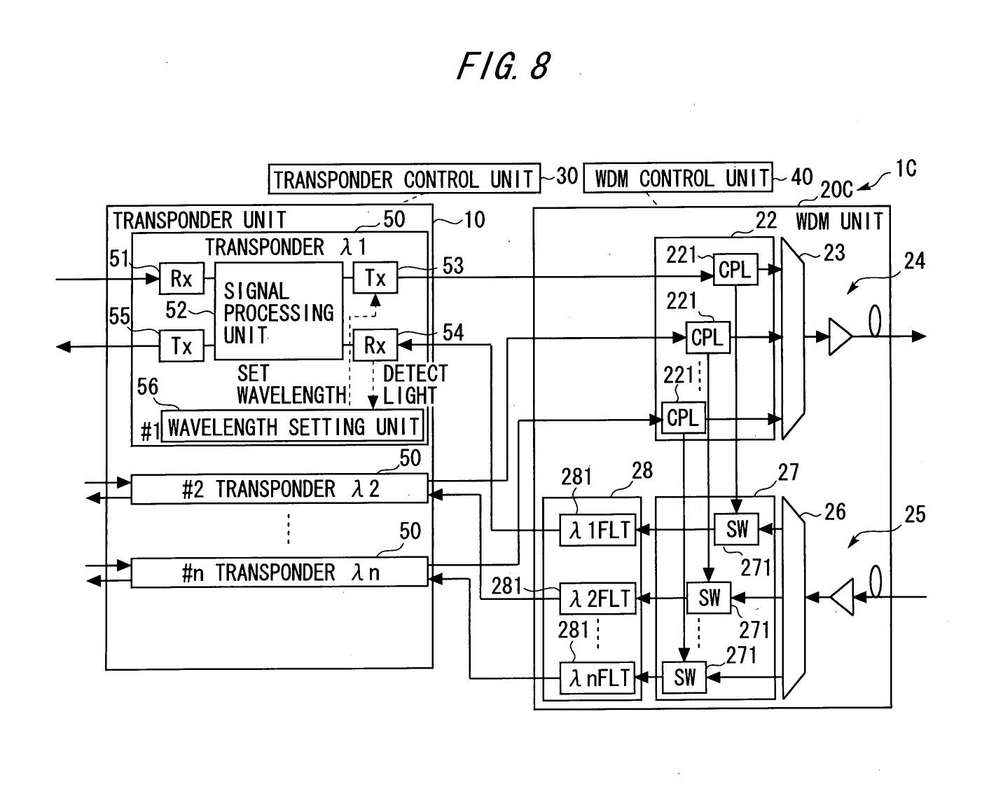

FIG. 8 is a diagram showing a structural example of a WDM transmission apparatus according to the fourth embodiment. A WDM transmission apparatus 1C corresponds to a modified example of the WDM transmission apparatus 1 (FIG. 2) according to the first embodiment. In FIG. 8, the same structural elements as those in the WDM transmission apparatus 1 are denoted by identical symbols.

The WDM transmission apparatus 1C is different from the WDM transmission apparatus 1 (FIG. 2) as follows: That is, a WDM unit 20C corresponding to the WDM unit 20 has no optical filter unit 21, taking the fact that the wavelength multiplex unit 23 exhibits the same filter effect as that of the optical filter into consideration. Therefore, the transmitting unit 53 of each of the transponders 50 is connected to the corresponding CPL 221 of the optical split unit 22 through an optical fiber or the like.

As a result, the WDM 20C is so structured as to have a loopback path composed of the CPL 221, the SW 271, and the optical filter 281 in the stated order in the respective wavelengths λ1 to λn. Accordingly, in the WDM transmission apparatus 1C, only when the wavelength of the light which is transmitted from the transmitting unit 53 is adapted to the pass wavelength of the optical filter 281, the receiving unit 54 can receive the light that has been returned through the loopback path. Except for the above structure, the WDM transmission apparatus 1C has the same structure as that in the WDM transmission apparatus 1.

The WDM transmission apparatus 1C executes the automatic wavelength setting according to the same automatic wavelength setting sequence (FIG. 3) as that in the WDM transmission apparatus 1. Therefore, the detailed operational example will be omitted.

<Operation and Effects>

The WDM transmission apparatus 1C according to the fourth embodiment can obtain the substantially same effects as those in the WDM transmission apparatus 1 described in the first embodiment. That is, the present invention has no optical filter on the first optical path, but can be applied to the WDM unit having the optical filter on the second optical path.

In other words, it is sufficient for the present invention to provide a region (pass wavelength region) that allows only a specific wavelength (wavelength band) to pass therethrough in at least one portion on the loopback path. In the case the pass wavelength region is realized by the optical filter, the location positions of the optical filters (pass band filters) on the loopback path and the number of optical filters are arbitrary.

### Fifth Embodiment

Subsequently, a description will be given of a wavelength division multiplexing apparatus (WDM transmission apparatus) according to a fifth embodiment of the present invention. The fifth embodiment includes the features common to those of the second embodiment, and therefore differences therebetween will be mainly described, and the description of the common features will be omitted.

<Apparatus Structure>

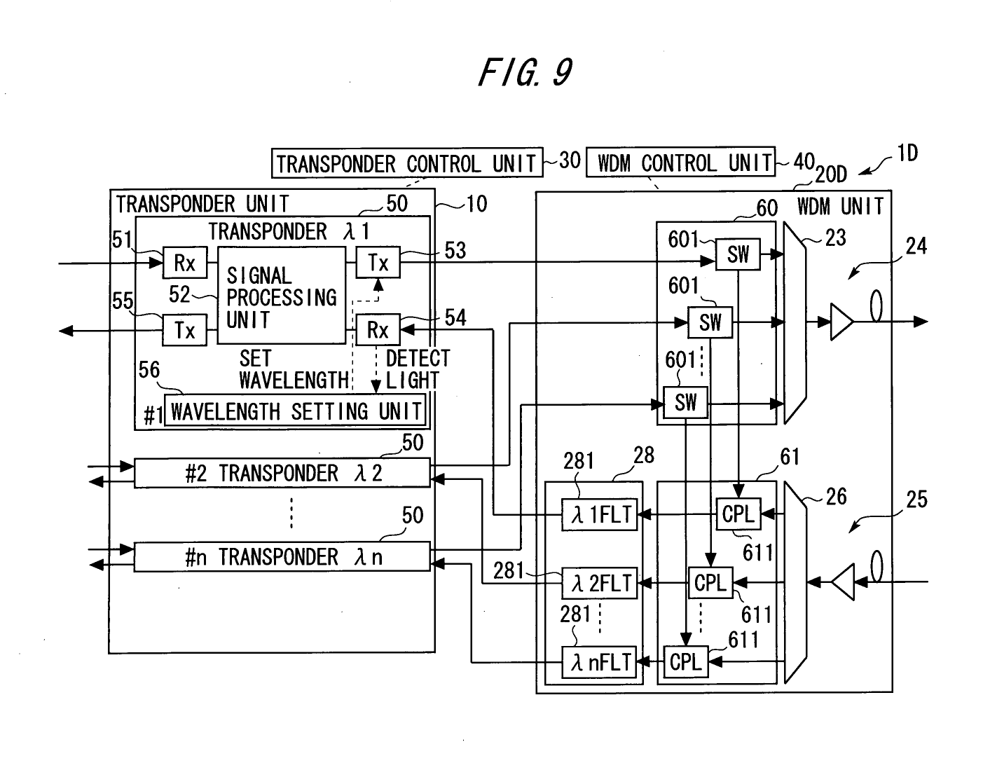

FIG. 9 is a diagram showing a structural example of a WDM transmission apparatus according to a fifth embodiment. A WDM transmission apparatus 1D corresponds to a modified example of the WDM transmission apparatus 1A (FIG. 4) according to the second embodiment. In FIG. 9, the same structural elements as those of the WDM transmission apparatus 1A are denoted by identical symbols.

The WDM transmission apparatus 1D is different from the WDM transmission apparatus 1A as follows: That is, a WDM unit 20D corresponding to the WDM unit 20 has no optical filter unit 21, taking the fact that the wavelength multiplex unit 23 exhibits the same filter effect as that of the optical filter into consideration. Therefore, the transmitting unit 53 of each of the transponders 50 is connected to the corresponding SW 601 of the optical switch unit 60 through an optical fiber.

As a result, the WDM 20D is so structured as to have a loopback path consisting of the SW601, the CPL 611, and the optical filter 281 in the stated order in the respective wavelengths λ1 to λn. Accordingly, in the WDM transmission apparatus 1D, only when the wavelength of the light which is transmitted from the transmitting unit 53 is adapted to the pass wavelength of the optical filter 281, the receiving unit 54 can receive the light that has been returned through the loopback path. Except for the above structure, the WDM transmission apparatus 1D has the same structure as that in the WDM transmission apparatus 1A.

The WDM transmission apparatus 1D executes the automatic wavelength setting according to the same automatic wavelength setting sequence (FIG. 5) as that in the WDM transmission apparatus 1A. Therefore, the detailed description of the operational example will be omitted.

<Operation and Effects>

According to the WDM transmission apparatus 1D of the fifth embodiment, there can be obtained the substantially same operation and effects as those in the WDM transmission apparatus 1A described in the second embodiment.

### Sixth Embodiment

Subsequently, a description will be given of a wavelength division multiplexing apparatus (WDM transmission apparatus) according to a sixth embodiment of the present invention. The sixth embodiment includes the features common to those of the third embodiment, and therefore differences therebetween will be mainly described, and the description of the common features will be omitted.

<Apparatus Structure>

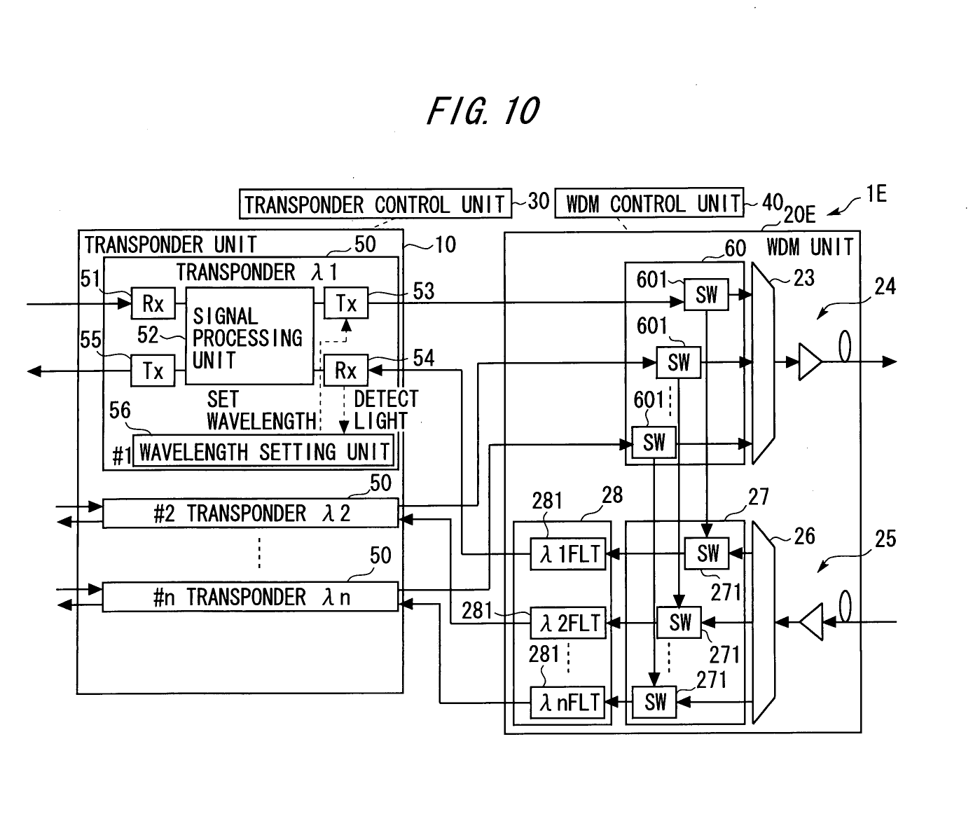

FIG. 10 is a diagram showing a structural example of a WDM transmission apparatus according to a sixth embodiment. A WDM transmission apparatus 1E corresponds to a modified example of the WDM transmission apparatus 1B (FIG. 6) according to the third embodiment. In FIG. 10, the same structural elements as those in the WDM transmission apparatus 1B are denoted by identical symbols.

The WDM transmission apparatus 1E is different from the WDM transmission apparatus 1B as follows: That is, a WDM unit 20E corresponding to the WDM unit 20 has no optical filter unit 21, taking the fact that the wavelength multiplex unit 23 exhibits the same filter effect as that of the optical filter into consideration. Therefore, the transmitting unit 53 of each of the transponders 50 is connected to the corresponding SW 601 of the optical switch unit 60 through an optical fiber.

As a result, the WDM 20E is so structured as to have a loopback path consisting of the SW601, the 2W 271, and the optical filter 281 in the stated order in the respective wavelengths λ1 to λn. Accordingly, in the WDM transmission apparatus 1E, only when the wavelength of the light which is transmitted from the transmitting unit 53 is adapted to the pass wavelength of the optical filter 281, the receiving unit 54 can receive the light that has been returned through the loopback path, as in the fourth and fifth embodiments. Except for the above structure, the WDM transmission apparatus 1E has the same structure as that in the WDM transmission apparatus 1B.

The WDM transmission apparatus 1E executes the automatic wavelength setting according to the same automatic wavelength setting sequence (FIG. 7) as that in the WDM transmission apparatus 1B. Therefore, the detailed description of the operational example will be omitted.

<Operation and Effects>

According to the WDM transmission apparatus 1E of the sixth embodiment, there can be obtained the substantially same operation and effects as those in the WDM transmission apparatus 1A described in the second embodiment.

### Seventh Embodiment

Subsequently, a description will be given of a wavelength division multiplexing apparatus (WDM transmission apparatus) according to a seventh embodiment of the present invention. The seventh embodiment includes the features common to those of the first, second, and fourth embodiments, and therefore differences therebetween will be mainly described, and the description of the common features will be omitted.

<Apparatus Structure>

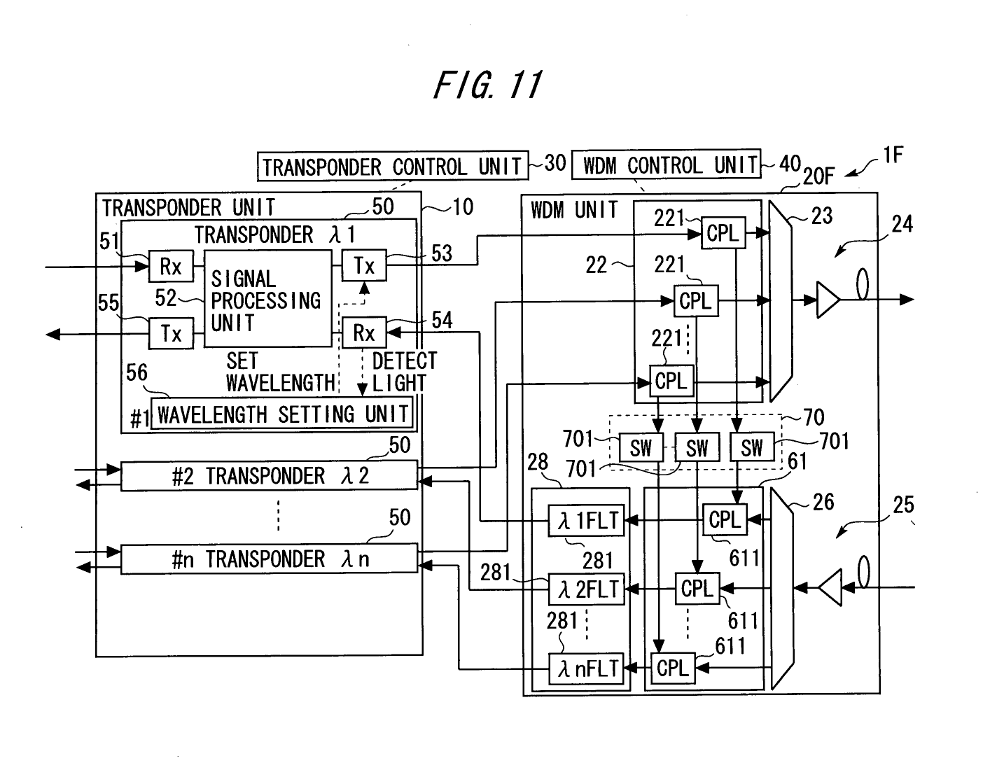

FIG. 11 is a diagram showing a structural example of a WDM transmission apparatus according to a seventh embodiment. In a WDM transmission apparatus 1F shown in FIG. 11, the same structural elements as those in the WDM transmission apparatus 1 (FIG. 2) according to the first embodiment and in the WDM transmission apparatus 1A (FIG. 4) according to the second embodiment are designated by identical symbols.

The WDM transmission apparatus 1F is different from that of the first and second embodiments in the structure of the WDM unit. A WDM unit 20F in the WDM transmission apparatus 1F includes the optical split unit 22, the wavelength multiplex unit 23, the optical amplifying units 24 and 25, the wavelength division unit 24, and the optical filter unit 28 which are included in the WDM unit 20 (FIG. 2) according to the first embodiment, and the optical coupling unit (light inserting unit) 61 which is included in the WDM unit 20A (FIG. 4) according to the second embodiment. In this example, the WDM unit 20F does not include the optical switch unit 21, and the connection relationship between the respective transponders 50 and the optical split unit 22 is identical with that of the fourth embodiment.

In addition, the WDM unit 20F includes an optical switch unit 70 that is disposed between the optical split unit 22 and the optical coupling unit 61. The optical switch unit 70 includes plural optical switches (SW) 701 that are arranged (inserted) on the connection optical paths which connect the CPLs 221 and the CPLs 611 corresponding to the respective wavelengths λ1 to λn. The respective SWs 701 switches over the light from the CPL 221 between a pass state and a non-pass state according to an on/off operation. The on/off control of the respective SWs 701 is executed by the WDM control unit 40. The respective SWs 701 are turned off at the time of operating the corresponding wavelength, and turned on at the time of the automatic wavelength setting.

Except for the above structure, the WDM transmission apparatus 1F has the same structure as that in the WDM transmission apparatuses 1 and 1A.

<Operational Example>

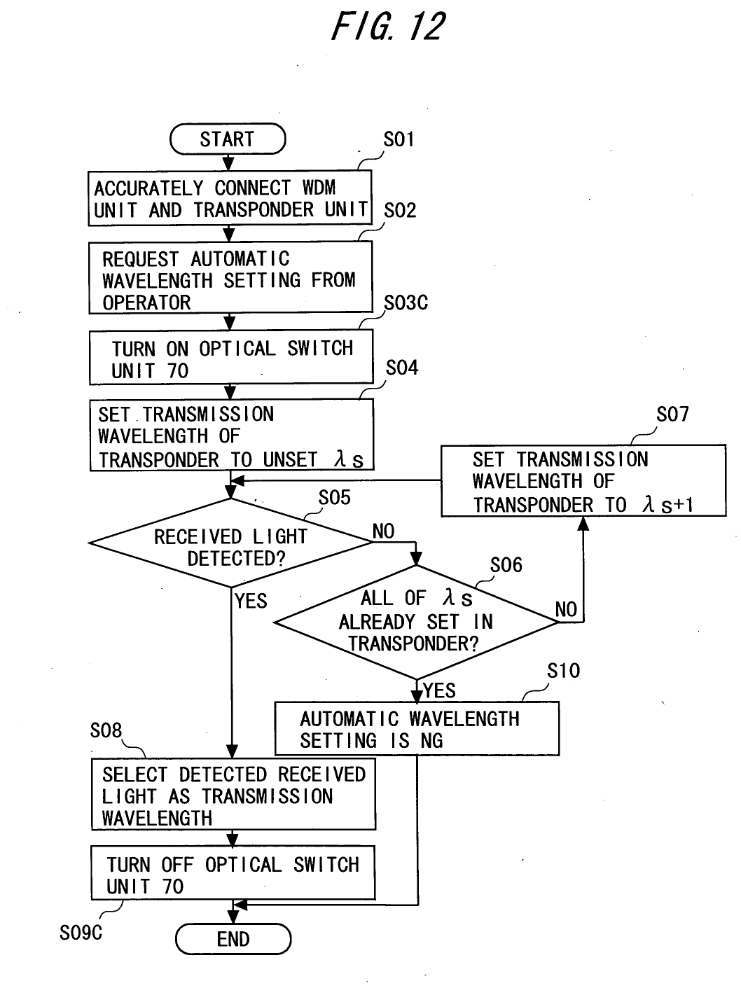

FIG. 12 is a diagram showing an automatic wavelength setting sequence which is executed by a WDM transmission apparatus 1F according to a seventh embodiment. A process shown in FIG. 12 (operational example) is different from the automatic wavelength setting sequence (FIG. 3) according to the first embodiment in Steps S03C and S09C.

In Step S03C, the WDM control unit 40 turns on an SW 701 corresponding to the transmission wavelength λs (designated wavelength) to be set in the transponder 50. As a result, the signal light that has been transmitted from the transmitting unit 53 is inputted to the CPL 611 through the SW 701 from the CPL 221. The CPL 611 inserts the signal light into an optical path directed toward the optical filter 281.

In Step S09C, after the transmission wavelength has been determined, the WDM control unit 40 turns off the SW 701 in the on state. As a result, the signal light from the wavelength division unit 61 and the signal light from the CPL 211 are prevented from being coupled with each other, and the operation state of the corresponding wavelength is ensured.

Except for the above structures, the automatic wavelength setting sequence according to the seventh embodiment is identical with that of the first embodiment. Therefore, the detailed description will be omitted. In the seventh embodiment, the light is not outputted from the wavelength division unit 26 at the time of the automatic wavelength setting.

<Operation and Effects>

According to the WDM transmission apparatus 1F of the seventh embodiment, there can be obtained the substantially same operation and effects as those of the WDM transmission apparatus 1 described in the first embodiment.

<Modified Example>

It is possible that the CPL 221 of the WDM unit 20F is replaced by the SW 601, or the CPL 611 is replaced by the SW 271.

### Eighth Embodiment

Subsequently, a description will be given of a wavelength division multiplexing apparatus (WDM transmission apparatus) according to an eighth embodiment of the present invention. The eighth embodiment includes the features common to those of the first embodiment, and therefore differences therebetween will be mainly described, and the description of the common features will be omitted.

<Apparatus Structure>

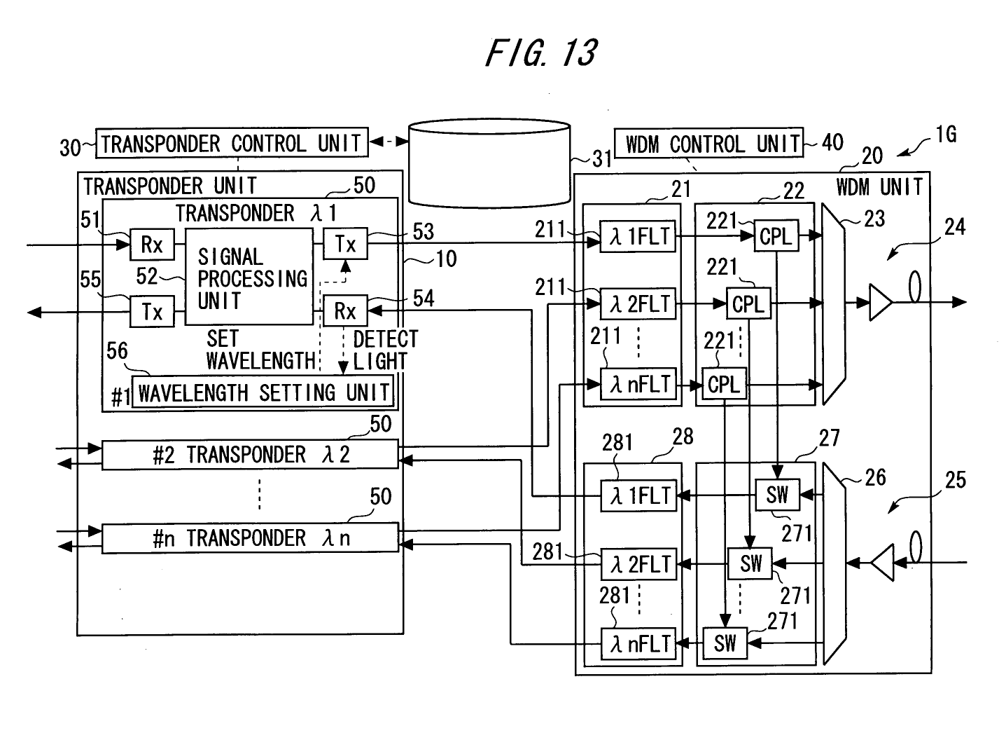

FIG. 13 is a diagram showing a structural example of a WDM transmission apparatus according to an eighth embodiment. A WDM transmission apparatus 1G corresponds to a modified example of the WDM transmission apparatus 1 (FIG. 2) according to the first embodiment. In FIG. 13, the same structural elements as those of the WDM transmission apparatus 1 are denoted by identical symbols.

In the WDM transmission apparatus 1G, the transponder control unit 30 is connected with a set wavelength information storage unit (storage unit) 31. The storage unit 31 stores information (wavelength information that has been already set) indicative of the wavelength λs that has been already set in the transponder unit 10 therein.

The wavelength setting unit 56 in each of the transponders 50 acquires the wavelength information that has been already set and stored in the storage unit 31 through the transponder control unit 30 on the basis of an instruction from the transponder control unit 30 in the case where the automatic wavelength setting is executed. The wavelength setting unit 56 removes the wavelengths that have been already set among all wavelengths λs which are used in the WDM transmission apparatus 1G from the wavelengths to be set in the transmitting unit 53, and executes the automatic wavelength setting process.

Except for the above structure, the WDM transmission apparatus 1G has the same structure as that of the WDM transmission apparatus 1.

<Operational Example>

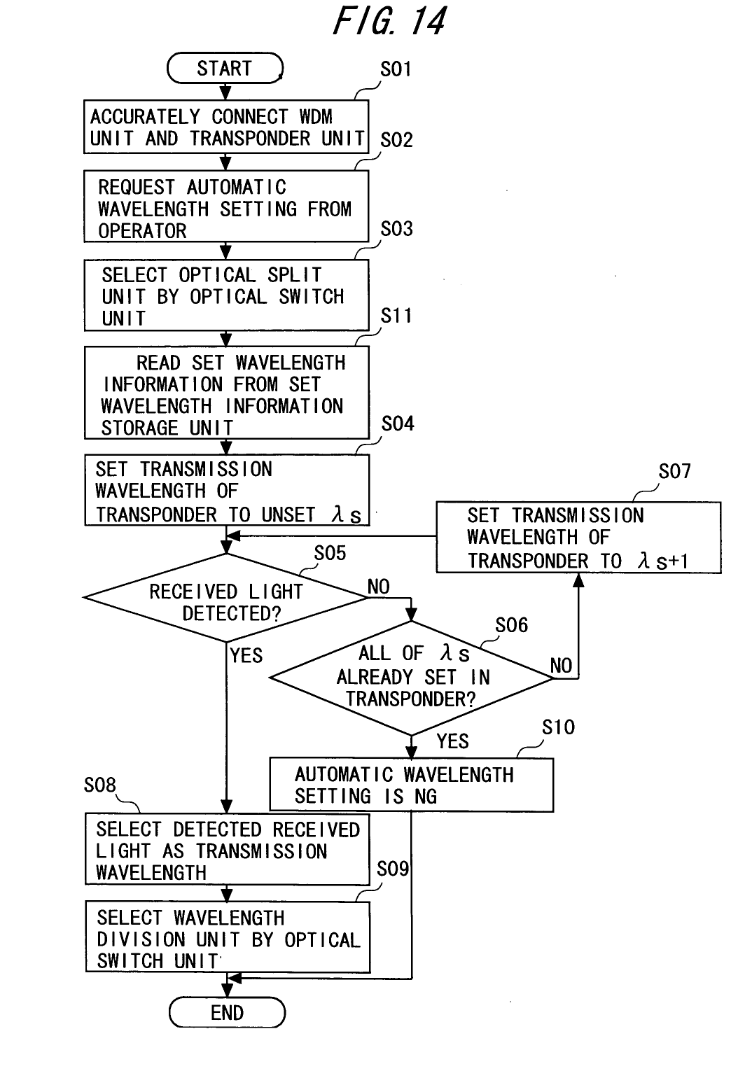

FIG. 14 is a diagram showing an automatic wavelength setting sequence which is executed by a WDM transmission apparatus 1G according to an eighth embodiment. A process shown in FIG. 14 (operational example) is substantially identical with the automatic wavelength setting sequence (FIG. 3) according to the first embodiment except that Step S11 is inserted between Step S03 and Step S04. Therefore, a description of the processes that are denoted by identical Step Nos. will be omitted.

In Step S11, the wavelength setting unit 56 that has received an instruction from the transponder control unit 30 reads the wavelength information that has been already set from the storage unit 31 through the transponder control unit 30, and then removes the wavelength that has been already set from all the wavelengths to be set. The wavelength setting unit 56 sets one of the remaining unused wavelengths from which the wavelengths that have been already set are removed in the transmitting unit 53 in Step S04.

<Operation and Effects>

The WDM transmission apparatus 1G according to the eighth embodiment can obtain the substantially same effects as those of the WDM transmission apparatus 1 described in the first embodiment. In addition, in the WDM transmission apparatus 1G, the wavelengths that have been already set in the transponder unit 10 are removed from the wavelengths to be set in the transmitting unit 53 (transmission wavelength candidates). As a result, since the maximum number of wavelengths to be set in the transmitting unit 53 is reduced in the automatic wavelength setting sequence, a period of time required for automatic wavelength setting can be reduced.

<Modified Example>

A structure in which the wavelengths that have been already set are stored in the storage unit 31, and the wavelengths that have been already set are removed from the wavelengths to be set as in the eighth embodiment can be applied to the WDM transmission apparatuses shown in the second to seventh embodiments. Also, the above structure is capable of being applied to a ninth embodiment which will be described later.

### Ninth Embodiment

Subsequently, a description will be given of a wavelength division multiplexing apparatus (WDM transmission apparatus) according to a ninth embodiment of the present invention. The ninth embodiment includes the features common to those of the first embodiment, and therefore differences therebetween will be mainly described, and the description of the common features will be omitted.

<Apparatus Structure>

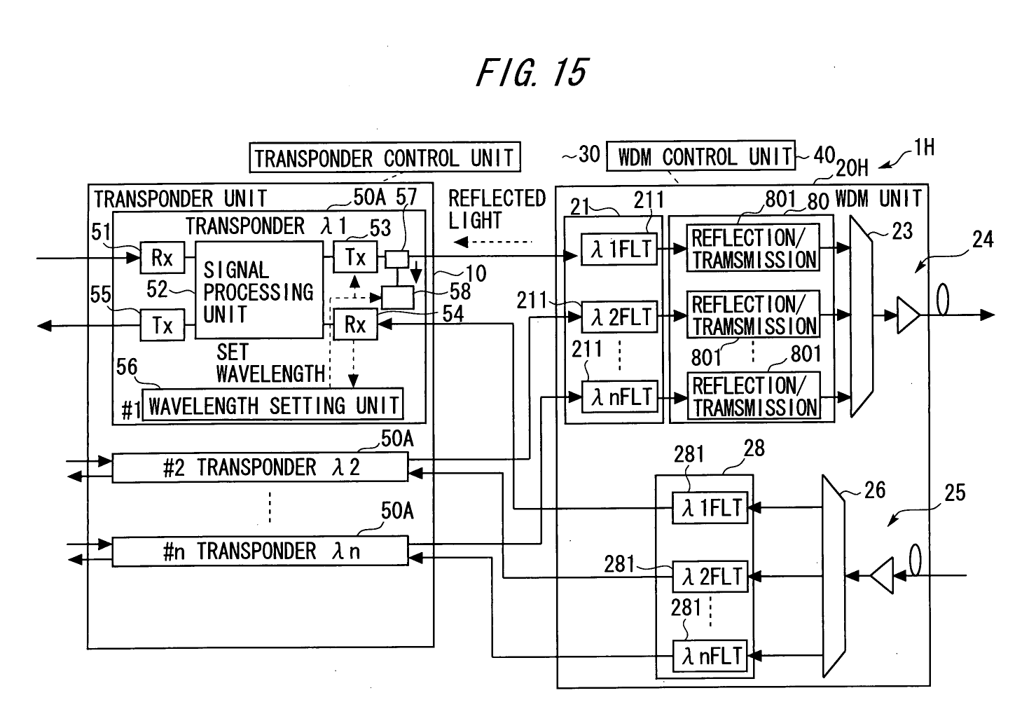

FIG. 15 is a diagram showing a structural example of a WDM transmission apparatus according to a ninth embodiment. A WDM transmission apparatus 1H is realized by the modification of the WDM transmission apparatus 1 (FIG. 2) according to the first embodiment, and in FIG. 15, the same structural elements as those of the WDM transmission apparatus 1 are denoted by identical symbols.

In the WDM transmission apparatus 1H, each of the transponders 50 A includes an optical fiber coupler (CPL) 57 which is disposed downstream of the transmitting unit 53 as a distributor, and a photodetector (e.g., photo diode: PD) 58 that detects a light split from the CPL 57.

When inputting the light in a direction from the WDM unit 20 toward the transponder 50A, the CPL 57 splits a part of the light to the PD 58. The PD 58 detects the light that is outputted from the CPL 57, and notifies the wavelength setting unit 56 of the light reception.

On the other hand, the WDM unit 20H is not equipped with the optical switch unit 27 having the WDM unit 20 (FIG. 2), and the wavelength division unit 26 and the optical filter unit 28 are connected directly to each other. On the other hand, a reflection/transmission unit 80 is disposed between the optical filter unit 21 and the wavelength multiplex unit 23 instead of the optical split unit 22 in the multiplex system.

The reflection/transmission unit 80 includes plural reflection/transmission units 801 corresponding to the respective wavelengths λ1 to λn. The respective reflection/transmission units 801 are disposed on the optical paths (first optical path) of the respective wavelengths λ1 to λn between the optical filter 211 and the wavelength multiplex unit 23.

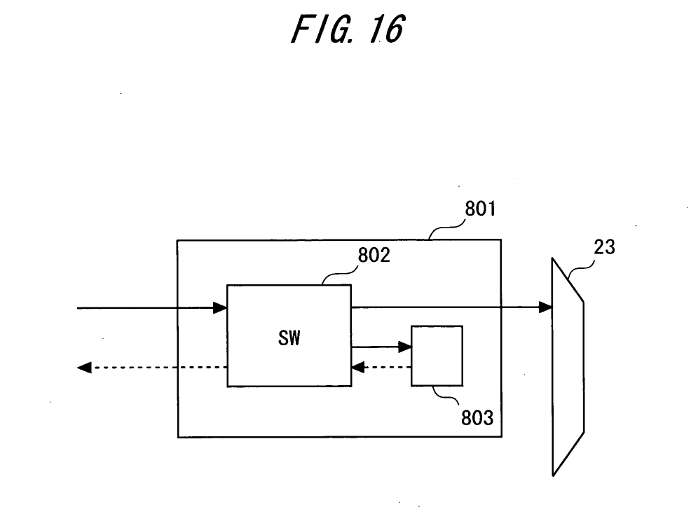

FIG. 16 is a diagram showing a structural example of a reflection/transmission unit 80. The reflection/transmission unit 80 includes an optical switch (SW) 802 that inputs a signal light from the optical filter 211, and a mirror 803 as a reflection unit.

The SW 802 switches over an outputted portion (connected portion) of a signal light inputted from the optical filter 211 (indicated by solid arrows of FIG. 16) between the wavelength multiplex unit 26 and the mirror 803 (selects one of them). The switching control of the SW 802 is conducted by the WDM control unit 40. When the SW 802 selects the wavelength multiplex unit 26, the signal light from the optical filter 211 transmits through the reflection/transmission unit and is inputted to the wavelength multiplex unit 26. On the contrary, when the SW 802 selects the mirror 803, the signal light from the optical filter 211 is outputted toward the mirror 803.

The mirror 803 totally reflects the signal light outputted from the SW 803. As a result, the reflected light from the mirror 803 (indicated by arrows of dotted lines of FIG. 16) is returned toward the optical filter 211 through the SW 802.

With the above structure, the signal light that is transmitted from the transmitting unit 53 is inputted to the reflection/transmission unit through the optical filter 211 when the wavelength of this signal light is adapted to the pass wavelength of the optical filter 211. In this situation, when the SW 802 selects the mirror 803, the signal light is reflected by the mirror 803. The reflected light of the mirror 803 passes through the SW 802, and is advanced toward the optical filter 211.

In addition, the reflected light passes through the optical filter 211, and reaches the transponder 50A which is a transmitting origin of the signal light. In this situation, the reflected light reaches the PD 58 through the CPL 57. Then, the PD 58 detects the reception of the reflected light and notifies the wavelength setting unit 56 of the detection result. Upon receiving the notification from the PD 58, the wavelength setting unit 56 determines the wavelength that is set in the transmitting unit 53 at this time as a transmission wavelength to be applied by the subject device (transponder 50A).

Except for the above structures, the WDM transmission apparatus 1H has the same structure as that of the WDM transmission apparatus. The transmitting unit 53 corresponds to the transmitting unit, the CPL 57 and the PD 58 correspond to the receiving unit, and the wavelength setting unit 56 corresponds to the control unit and the determining unit.

<Operational Example>

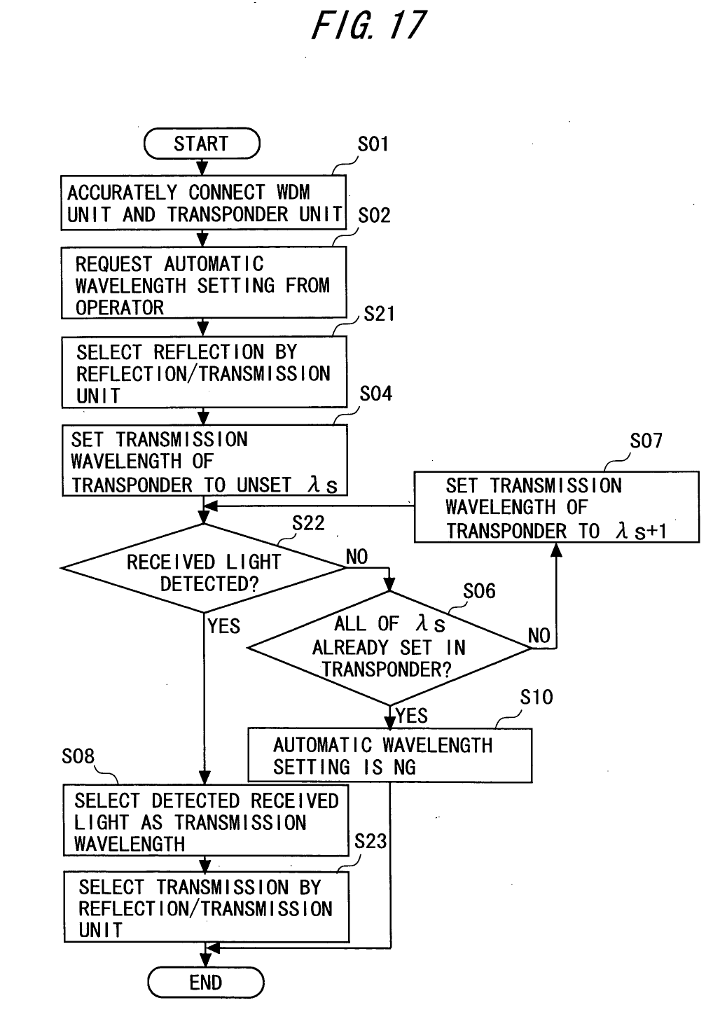

FIG. 17 is a diagram showing an automatic wavelength setting sequence which is executed by a WDM transmission apparatus 1G according to a ninth embodiment. A process shown in FIG. 17 (operational example) is substantially identical with the automatic wavelength setting sequence (FIG. 3) according to the first embodiment except for differences indicated by the following items (1) to (3). Therefore, a description of the processes that are denoted by identical Step Nos. in FIG. 17 will be omitted.
(1) Step S21 is executed instead of Step S03.
(2) Step S22 is executed instead of Step S05.
(3) Step S23 is executed instead of Step S09.

In Step S21, the reflection/transmission unit 80 selects “reflection”. That is, the WDM control unit 40 that has received the request command of the automatic wavelength setting from the operator allows the respective reflection/transmission units 801 corresponding to the wavelengths (wavelengths to be set) which are discriminated from the request command to select the mirror 803.

In Step S22, the wavelength setting unit 56 monitors the reception of the reflected light by the PD 58 until a given period of time elapses since the wavelength is set in the transmitting unit 53. In the case where the reception is detected within a given period of time (YES in S22), processing is advanced to Step S08, and in the case where the reception is not advanced to Step S08 (NO in Step 22), processing is advanced to Step S06.

In Step S23, “transmission” is selected by the reflection/transmission unit 80. That is, the WDM control unit 40 recognizes that the automatic wavelength setting of some transponder 50A has been completed, for example, by notification from the transponder control unit 30. Then, the WDM control unit 40 switches over the state of the corresponding reflection/transmission unit 801 to the selection of the wavelength multiplex unit 26 on the basis of the recognition.

<Operation and Effects>

The WDM transmission apparatus 1H according to the ninth embodiment can obtain the substantially same effects as those of the WDM transmission apparatus 1 described in the first embodiment. In addition, in the WDM transmission apparatus 1H, since the loopback path is structured by using only the multiplex system, a portion related to the modification of the WDM unit can be reduced. That is, the WDM unit 20H can be so structured as to have the loopback path only by inserting the reflection/transmission unit 80.

<Modified Example>

A structure related to the automatic wavelength setting described in the ninth embodiment can be applied to a wavelength multiplexing apparatus having only the multiplex system in the WDM transmission apparatus.

[Others]

The disclosures of Japanese patent application No. JP2005-286661 filed on Sep. 30, 2005 including the specification, drawings and abstract are incorporated herein by reference.

What is claimed is:

1. A wavelength division multiplexing apparatus, comprising:
a transponder unit that transmits a plurality of signal lights each having a different wavelength from each other; and
a wavelength division multiplexing unit that receives the plurality of signal lights, multiplexes the received signal lights in wavelength, and transmits the multiplexed signal light, and when receiving wavelength-multiplexed signal lights, divides the wavelength-multiplexed signal light into plural signal lights having the different wavelengths, and transmits the respective divided signal lights to the transponder unit,
wherein the transponder unit includes a plurality of transponders, each of which transmits and receives the signal light having one of the plurality of wavelengths with respect to the wavelength division multiplexing unit,
wherein the wavelength division multiplexing unit is connected to one of the plural transponders, has a specific pass wavelength, and has a loopback path that returns the signal light to one of the transponders when the wavelength of the signal light that is received from one of the transponders is adapted to the pass wavelength, and
wherein one of the transponders, comprises:
a transmitting unit that can transmit the signal light having a wavelength according to the setting to the wavelength division multiplexing unit;
a detection unit detecting the signal light that is returned through the loopback path; and
a control unit conducting wavelength setting on the transmitting unit and determining, as a transmission wavelength to be used in the one of the transponders, the wavelength that has been setting in the transmitting unit when the detecting unit detects the signal light.

2. The wavelength division multiplexing apparatus according to claim 1, wherein the wavelength division multiplexing unit includes a wavelength multiplex unit that multiplexes the plurality of signal lights in wavelength, and a wavelength division unit that divides the wavelength-multiplexed signal light into a plurality of signal lights having different wavelengths from each other, and
wherein the loopback path comprises:
a first optical path through which a signal light from one of the transponders reaches the wavelength multiplex unit since the signal light is received by the wavelength division multiplexing unit;
a second optical path through which one of the signal lights that are outputted from the wavelength division unit is transmitted from the wavelength division multiplexing unit toward the transponder; and
a connection optical path that connects the first optical path and the second optical path.

3. The wavelength division multiplexing apparatus according to claim 2, wherein an optical splitter that distributes the signal light progressing toward the wavelength division unit through the first optical path to the connection optical path is disposed at a cross point of the first optical path and the connection optical path, and
wherein an optical switch that switches over a light which progresses toward one of the transponders on the second optical path between a signal light from the optical splitter and a signal light which is outputted from the wavelength division unit is disposed at a cross point of the second optical path and the connection optical path.

4. The wavelength division multiplexing apparatus according to claim 2, wherein an optical switch that switches over a connected portion of the signal light which progresses toward the wavelength multiplex unit through the first optical path between the wavelength multiplex unit and the connection optical path is disposed at a cross point of the first optical path and the connection optical path, and
wherein an insertion unit that inserts the signal light from the optical switch into the second optical path is disposed at a cross point of the second optical path and the connection optical path.

5. The wavelength division multiplexing apparatus according to claim 2, wherein an optical switch that switches over a connected portion of the signal light which progresses toward the wavelength multiplex unit through the first optical path between the wavelength multiplex unit and the connection optical path is disposed at a cross point of the first optical path and the connection optical path, and
wherein an optical switch that switches over a light which progresses toward the transponders on the second optical path between a signal light from the optical splitter and a signal light which is outputted from the wavelength division unit is disposed at a cross point of the second optical path and the connection optical path.

6. The wavelength division multiplexing apparatus according to claim 2, wherein a switch that turns on/off the progression of the signal light on the connection optical path is disposed on the connection optical path.

7. The wavelength division multiplexing apparatus according to claim 1, wherein a reflecting unit reflecting the signal light is disposed on the loopback path, and
wherein the signal light that is reflected by the reflecting unit is returned to one of the transponders along a path through which the signal light passes until the signal light reaches the reflecting unit.

8. The wavelength division multiplexing apparatus according to claim 1, wherein a set wavelength candidate that is set in the transmitting unit is defined by the control unit,
wherein the apparatus further comprises a storage unit storing information that can identify a wavelength which is in use by the transponder unit, and
wherein the wavelength that is in use is precluded from the set wavelength candidate on the basis of the information stored in the storage unit.

9. An automatic transmission wavelength setting method for a wavelength division multiplexing apparatus which comprises: a transponder unit that transmits a plurality of signal lights each having a different wavelength from each other; and
a wavelength division multiplexing unit that receives the plurality of signal lights, multiplexes the received signal lights in wavelength, and transmits the multiplexed signal light, and when receiving the wavelength-multiplexed signal lights, divides the wavelength-multiplexed signal light into plural signal lights having the different wavelengths, and transmits the respective divided signal lights to the transponder unit,
wherein the transponder unit includes a plurality of transponders, each of which transmits and receives the signal light having one of the plurality of wavelengths with respect to the wavelength division multiplexing unit, the method comprising:
transmitting the signal light to the wavelength division multiplexing unit by one of the plurality of transponders;
receiving the signal light that returns back from the wavelength division multiplexing unit when the wavelength of the signal light is a wavelength to be used by the one of the plurality of transponders; and
determining, when the signal light is received, the wavelength of the signal light as a transmission wavelength to be used by the one of the plurality of transponders.

10. A transponder for transmitting one of a plurality of signal lights having different wavelengths from each other to a device that multiplexes the plurality of signal lights in wavelength, the transponder comprising:
a transmitting unit transmitting the signal light to the device;
a receiving unit receiving the signal light that returns back from the device when the wavelength of the signal light is a wavelength to be used by the transponder; and
a unit determining, when the signal light is received by the receiving unit, the wavelength of the received signal light as the transmission wavelength to be used by the transponder.
